(19) United States
(12) Patent Application Publication
(10) Pub. No.: US 2014/0320672 A1
(43) Pub. Date: Oct. 30, 2014

(54) Method and Apparatus for Measuring Flange Back Focus and Calibrating Track Length Scales of Photographic Objective Lenses

(71) Applicant: Cooke Optics Limited, Leicester (GB)

(72) Inventor: Rowland Little, East Langton (GB)

(73) Assignee: Cooke Optics Limited, Leicester (GB)

(21) Appl. No.: 14/261,190

(22) Filed: Apr. 24, 2014

Related U.S. Application Data
(60) Provisional application No. 61/817,141, filed on Apr. 29, 2013.

(51) Int. Cl. H04N 17/00

(52) U.S. Cl. CPC H04N 17/002
USPC 348/187

(57) ABSTRACT

The illuminated object is brought to focus by a microscope objective lens in a focal plane. This image acts as the object for the lens under test. The position of the focal plane is adjusted by moving the object generator/viewing stage in the form of an autocollimator with a split beam eyepiece until it is coincident with the infinity focal plane of the lens under test. When this condition has been achieved, light transmitted by the test lens will be collimated. This collimated beam is reflected by a plane mirror and re-enters the test lens to be imaged in the focal plane and provide a well-focussed image as viewed by through the eyepiece. This image is also available for analysis using photoelectric techniques.

### BACKGROUND OF THE INVENTION

1. Field of the Invention

The present invention relates to cinematographic lenses and more particularly to a method and apparatus for measuring and setting the back focus and calibrating the track length of cinematographic lenses.

2. Description of Prior Art Including Information Disclosed Under 37 CFR 1.97 and 1.98

Photographic objective lenses designed for use with 35 mm cinematographic cameras are required to incorporate a focussing mechanism and a scale indicating the distance from a specified focal plane to an in focus object. This object to focal plane distance is referred to as the track length.

The focus scale of the lens is required to be calibrated in terms of track length over a range of track lengths from infinity to a minimum value specified in the lens design. In addition to these two extreme positions, the calibrated track length scale is required to include intermediate track lengths as specified in the product design.

All calibrated track lengths must be referenced to a common focal plane. The common or datum focal plane adopted by the professional cinephotographic industry is specified as being located 52.000 mm from the lens mounting flange of the camera where the optimum focus of the image of an object is located at an infinite track length.

In calibration/testing procedures, the infinite track length is usually provided by a collimator or an autocollimator. In a collimator, as illustrated in FIG. 1, the lens is tested in single pass transmission mode where light from object 10 passes through a collimator lens 12 and the lens 14 being tested and is viewed in microscope 16. In an autocollimator, as illustrated in FIG. 2, the lens is tested in double pass transmission mode where the light from object 10 passes through collimator lens 12 and the lens 14 being tested and then is reflected back through the test lens and collimator lens by a planar mirror 18 to a split beam eyepiece 20 where it is observed at 22.

Both of those conventional techniques for finding the infinite track length present practical difficulties. The collimator or autocollimator must have a physical aperture equal in size to the full aperture of the lens under test. This can result in the need for large and expensive equipment, particularly with respect to the testing of Fast (T Number<2.0), long focal length (focal length>100 mm) lenses. Moreover, the test equipment must exhibit aberrations significantly less than those present in the test lens in order not to influence the precision of the measurement.

The present invention is designed to overcome those difficulties. It provides a method for measuring the infinite track length of a test lens using equipment which is a variant of the autocollimator technique. Like the conventional autocollimator, in the present invention the infinite track length is produced by a reflection from a planar mirror using a split beam eyepiece. The eyepiece is utilized as a combined object generator/viewing stage to provide an illuminated object as in the conventional autocollimator but in the present invention also functions as the means for assessing and adjusting the quality of the focussed image. As a result, the need to another (collimator) lens is eliminated.

The position of the split beam eyepiece relative to the focal plane is adjustable horizontally. Adjusting the position of the eyepiece allows the flange back focus (the distance of the mounting flange of the lens under test from the assessed focal plane) to be varied until optimum focus of the image is achieved. The position of the eyepiece is then referenced to the position of the industry standard common or datum focal plane in order to calibrate the track length.

### BRIEF SUMMARY OF THE INVENTION

In accordance with the present invention, a method is provided for establishing infinity back focus of a cinematographic lens of the type having a focal point. The method includes focusing light from an illuminated image of an object to a focal plane and through the lens; reflecting the light back through the lens and the focal plane to a position wherein the image can be observed; moving the focal plane relative to the lens; observing the focus of the image as the focal plane is moved relative to the lens; and setting the position of the focal plane to coincide with the focal point of the lens by observing the sharpness of the image.

The method also includes the step of using the distance between the set position of the focal plane and the object to set the back focus of the lens.

The step of reflecting includes using a planar mirror.

The step of collimating light from an illuminated object includes the step of using an autocollimator for collimating the light from the illuminated object.

The step of focusing the collimated light on a focal plane and through the lens includes the step of using a microscope objective to focus the collimated light on the focal plane.

The step of reflecting the light back through the lens and the focal plane to a position wherein the image can be observed includes using a planar mirror to reflect the light.

The step of reflecting the light back through the lens and the focal plane to a position wherein the image can be observed includes the step of splitting the light such that the image can be observed.

The step of observing the focus of the image as the lens moves relative to the focal plane includes analyzing the image using photoelectric techniques.

The step of analyzing the image using photoelectric techniques includes displaying the image using a camera and monitor.

The step of analyzing the image using photoelectric techniques includes numerically analyzing the image to derive the Modulation Transfer Function at a selected frequency over an appropriate Spatial Frequency Range.

In accordance with another aspect of the present invention, a method is provided for establishing infinity back focus of a cinematographic lens of the type having a focal point using an autocollimator including a beam splitter eyepiece through which the image of an illuminated object may be viewed and a planar mirror. The method includes focusing the collimated light from the autocollimator to a focal plane and through the lens to the mirror; moving the autocollimator relative to the lens such that the focal plane of the autocollimator moves relative to the focal point of the lens; observing the focus of the image through the autocollimator eyepiece as the focal plane of the autocollimator moves relative to the focal point of the lens; and setting the position of the autocollimator such that the focal plane of the autocollimator coincides with the focal point of the lens by observing the sharpness of the image.

The step of focusing the collimated light from the autocollimator to a autocollimator focal plane includes using a microscope objective to focus the collimated light from the autocollimator.

The step of observing the focus of the image through the autocollimator eyepiece as the focal plane of the autocollimator moves relative to the focal point of the lens includes analyzing the observed image using photoelectric techniques.

In accordance with another aspect of the present invention, a method is provided for establishing infinity back focus of a cinematographic lens of the type having a focal point using a microscope objective, an autocollimator having a beam splitter eyepiece through which the image of an illuminated object may be viewed, and a planar mirror. The method includes focusing the collimated light from the autocollimator to a autocollimator focal plane using the microscope objective; moving the autocollimator relative to the lens such that the focal plane of the autocollimator moves relative to the focal point of the lens; observing the focus of the image through the autocollimator eyepiece as the focal plane of the autocollimator moves relative to the focal point of the lens; and setting the position of the autocollimator such that the focal plane of the autocollimator coincides with the focal point of the lens by observing the sharpness of the image.

In accordance with another aspect of the present invention, apparatus is provided for establishing infinity back focus of a cinematographic lens of the type having a focal point. The apparatus includes means for collimating light from an illuminated object; means for focusing the collimated light on a focal plane and through the lens; means for reflecting the light back through the lens and the focal plane to a position wherein the image can be observed; means for moving the focal plane relative to the focal point of the lens; and means for observing the focus of the image as the focal plane is moved relative to the focal point of the lens such that the position of the focal plane that coincides with the focal point of the lens can be determined by observing the sharpness of the image.

The means for collimating light from an illuminated object comprises an autocollimator.

The means of focusing the collimated light on a focal plane and through the lens comprises a microscope objective.

The means of reflecting the light back through the lens and the focal plane to a position wherein the image can be observed includes a planar mirror.

The means of reflecting the light back through the lens and the focal plane to a position wherein the image can be observed includes a beam splitter.

The means of observing the focus of the image as the focal plane moves relative to the focal point of the lens includes a camera and monitor.

The means of observing the focus of the image as the focal plane moves relative to the focal point of the lens includes means for numerically analyzing the image to derive the Modulation Transfer Function at a selected frequency over an appropriate Spatial Frequency Range.

In accordance with another aspect of the present invention, apparatus for establishing infinity back focus of a cinematographic lens of the type having a focal point using a planar mirror is provided. The apparatus includes an autocollimator with a beam splitter eyepiece through which the image of an illuminated object may be viewed; a microscope objective for focusing the collimated light from the autocollimator to a autocollimator focal plane; means for moving the autocollimator relative to the lens such that the focal plane moves relative to the focal point of the lens such that the beam splitter eyepiece allows observation of the focus of the image as the focal plane moves relative to the focal point of the lens; and means for determining the position of the autocollimator when the observed image appears to be sharpest.

In accordance with another aspect of the present invention, apparatus for establishing infinity back focus of a cinematographic lens of the type having a focal point using a microscope objective and a planar mirror is provided. The apparatus includes an autocollimator having a beam splitter eyepiece through which the image of an illuminated object may be viewed; a microscope objective for focusing the collimated light from the autocollimator through a focal plane and the lens to the mirror such that the mirror reflects the light back through the lens and the focal plane to the beam splitter eyepiece; means for moving the autocollimator relative to the lens such that the focal plane moves relative to the focal point of the lens; means for observing the focus of the image through the beam splitter eyepiece as the focal plane moves relative to the focal point of the lens; and photoelectric means for determining the position of the autocollimator when the observed image is sharpest.

The photoelectric means comprises a camera and a monitor or a numeric analyzer for deriving the Modular Transfer Function of an appropriate Spatial Frequency Range or one particular frequency.

### BRIEF DESCRIPTION OF THE SEVERAL VIEWS OF DRAWINGS

To these and to such other objects that may hereinafter appears, the present invention relates to a method and apparatus for measuring flange back focus and calibrating track length scales of photographic objective as described in detail in the following specification and recited in the annexed claims, taken together with the accompanying drawings, in which like numerals refer to like parts and in which:

FIG. 1 is a schematic drawing of a conventional collimator;

FIG. 2 is a schematic drawing of a conventional autocollimator; and

FIG. 3 is a schematic drawing of the apparatus of the present invention.

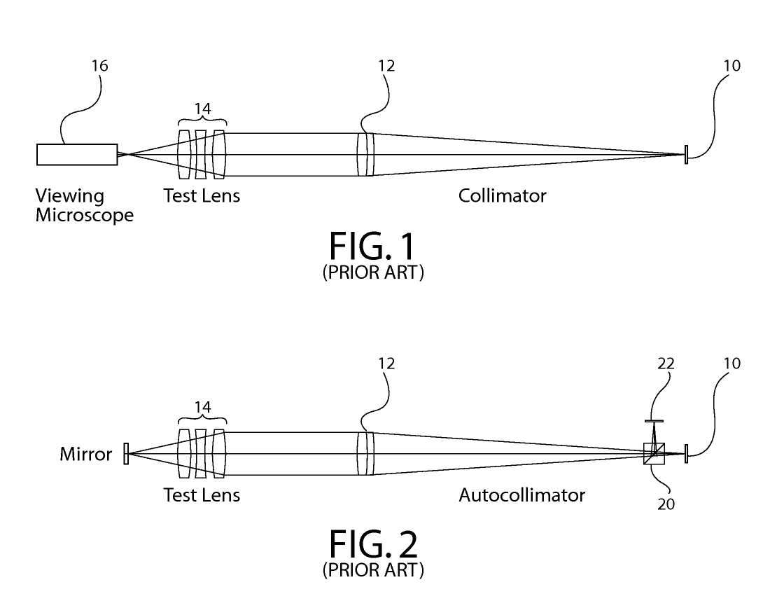

### DETAILED DESCRIPTION OF THE INVENTION

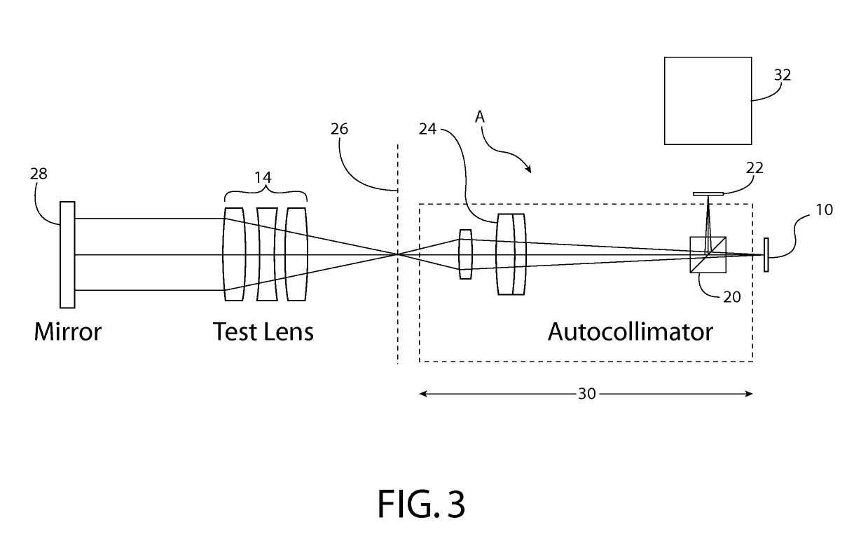

As illustrated in FIG. 3, the apparatus of the present invention includes an autocollimator, generally designated A, consisting of a split beam eyepiece 20 through which light from an illuminated object 10 enters the autocollimator and through which an image 22 from the autocollimator can be observed. The autocollimator also includes a microscope objective 24 which focuses light from eyepiece 20 on a focal plane 26.

Light from autocollimator A is focused through focal plane 26 and through lens 14 being tested to a planar mirror 28. Lens 14 has a focal point. The light is reflected from mirror 28 back through lens 14, focal plane 26 and microscope objective 24 to eyepiece 20 where it can be observed at 22.

As is indicated by arrow 30, autocollimator A, including microscope objective 24 and eyepiece 20, can be moved horizontally relative to lens 14 such that focal plane 26 moves relative to lens 14 and thus the focal point of lens 14. Autocollimator A may be mounted on to a translation stage, trolley or the like (not shown) for this purpose. As the autocollimator is moved relative to lens 14, the image at 22 can be observed.

The focus of the observed image will be sharpest when the focus plane of the autocollimator coincides with the focal point of lens 14. When that condition is observed, light transmitted by lens 14 will be collimated.

Mirror 28 must be flat such that it reflects the light back through the lens and collimator optics and the image is formed in the eyepiece. Preferably, the angle of the mirror relative to the horizontal is adjustable to compensate for lens boresight errors. The mirror is formed to be inherently free of chromatic aberrations. However, it is relatively inexpensive to produce a mirror of the required flatness.

The position of the autocollimator relative to lens when the observed image is sharpest is now determined. That distance is used to locate the mechanical mounting interface which carries the lens relative to the sensor plane of the sensor module to which it is attached.

The translation stage upon which the autocollimator is mounted may be fitted with a linear encoder and it is possible to measure the position of the back focus based upon previous measurement of a mechanical reference calibration tool. Using that measurement, the flange back focus of the lens can be set to its required distance. This is often achieved by the adjustment of shims.

The numerical aperture of the microscope and the diameter of the mirror must be selected to cover the largest entrance pupil diameter of the lenses to be measured using the equipment. The configuration of the measurement equipment results in an image that is the same size for all focal lengths measured on the equipment. This makes the judgment of focus by operators more consistent that the traditional method employing a collimator in which images of varying magnification are formed.

Image focus can be determined by visual techniques by suitably experienced operators. However, it is also possible to use photoelectric analyzing equipment 32 to perform this task. The photoelectric analyzing equipment can take the form of a camera and a monitor or a numeric analyzer which derives the Modulation Transfer Function over an appropriate spatial frequency range or at one particular frequency.

The common or datum focal plane is established by using a datum target or mirror which is incorporated into a fixture which replaces the lens under test. The distance between this target or mirror from the lens mounting flange interface is adjusted to be 52.000 mm in accordance with the industry standard. The process described above is then repeated and the optimum focus can be established visually or photoelectrically.

The difference between the two positions of the autocollimator (the optimum focus of the lens infinity setting and the optimum setting of the datum target) represents the required adjustment to the lens flange back focus to achieve the desired condition.

The apparatus of the present invention has many advantages over conventional equipment used for this purpose. Plane mirrors suitable for use with the apparatus of the invention of the required flatness specification (/10) are readily available with diameters up to 150 mm. This would be adequate to test a full range of lenses at full aperture. Such plane mirrors do not exhibit significant spectral variations. Plane mirrors are manufactured from well annealed material are stable and also easily calibrated.

The viewed image from the invention is the same size for all test lens focal lengths.

The equipment is relatively small and compact. It is relatively inexpensive to fabricate.

Repeatability of focal plane settings has been shown to be of the order of +/−0.004 mm.

A stable relatively inexpensive datum target/mirror can be provided.

Variations from the visual assessment of the image can easily be incorporated, if it is felt necessary to reduce the subjective nature of the assessment.

Depending on lens transmission values, T Numbers approaching T 1.0 can be accommodated.

The Object Generator/Viewing Stage in the form of an autocollimator can be easily incorporated into equipment used for calibrating track lengths other than infinity. This provides the ability to calibrate the full range of required track lengths in a common focal plane. Accordingly, both aspects of the requirement can be achieved in one measurement procedure.

Finally, the test conditions for the calibration procedure can be controlled and maintained for all calibrated track length

It will now be appreciated that the present invention pertains to a method and apparatus in which the illuminated object is brought to focus by a microscope objective lens in a focal plane. This image acts as the object for the lens under test. The position of the focal plane is adjusted by moving the object generator/viewing stage in the form of an autocollimator with a split beam eyepiece until it is coincident with the infinity focal plane of the lens under test. When this condition has been achieved, light transmitted by the test lens will be collimated. This collimated beam is reflected by a plane mirror and re-enters the test lens to be imaged in the focal plane and provide a well-focussed image as viewed by through the eyepiece. This image is also available for analysis using photoelectric techniques; being either displayed using a camera and suitable monitor screen or numerically analysed to derive the Modulation Transfer Function over an appropriate spatial frequency range or at one particular frequency.

The datum focal plane is established by using a datum target or mirror which is incorporated into a fixture which replaces the lens under test. The distance of this target or mirror from the lens mounting flange interface is adjusted to be 52.000 mm, in accordance with industry standards. Again optimum focus can be established visually or photoelectrically.

While only a single preferred embodiment of the present invention has been disclosed for purposes of illustration, it is obvious that many modifications and variations could be made thereto. It is intended to cover all of those modifications and variations which fall within the scope of the present invention, as defined by the following claims.

I claim:

1. A method for establishing infinity back focus of a cinematographic lens of the type having a focal point, said method comprising the steps of:
(a) focusing light from an illuminated image of an object to a focal plane and through the lens;
(b) reflecting the light back through the lens and the focal plane to a position wherein the image can be observed;
(c) moving the focal plane relative to the lens;
(d) observing the focus of the image as the focal plane is moved relative to the lens; and
(e) setting the position of the focal plane to coincide with the focal point of the lens by observing the sharpness of the image.

2. The method of claim 1 further comprising the step of using the distance between the set position of the focal plane and the object to set the back focus of the lens.

3. The method of claim 2 wherein the step of wherein the step of reflecting comprises the step of using a planar mirror.

4. The method of claim 1 wherein the step of collimating light from an illuminated object comprises the step of using an autocollimator for collimating the light from the illuminated object

5. The method of claim 1 wherein the step of focusing the collimated light on a focal plane and through the lens comprises the step of using a microscope objective to focus the collimated light on the focal plane.

6. The method of claim 1 wherein the step of reflecting the light back through the lens and the focal plane to a position wherein the image can be observed comprises the step of using a planar mirror to reflect the light.

7. The method of claim 1 wherein the step of reflecting the light back through the lens and the focal plane to a position wherein the image can be observed comprises the step of splitting the light such that the image can be observed.

8. The method of claim 1 wherein the step of observing the focus of the image as the lens moves relative to the focal plane comprises the step of analyzing the image using photoelectric techniques.

9. The method of claim 8 wherein the step of analyzing the image using photoelectric techniques comprises the step of displaying the image using a camera and monitor.

10. The method of claim 8 wherein the step of analyzing the image using photoelectric techniques comprises the step of numerically analyzing the image to derive the Modulation Transfer Function.

11. The method of claim 10 wherein the step of numerically analyzing the image to derive the Modulation Transfer Function further comprises the step of analyzing the image to derive the Modulation Transfer Function at a selected frequency.

12. The method of claim 10 wherein the step of numerically analyzing the image to derive the Modulation Transfer Function further comprises the step of analyzing the image to derive the Modulation Transfer Function over an appropriate spatial frequency range.

13. A method for establishing infinity back focus of a cinematographic lens of the type having a focal point using an autocollimator including a beam splitter eyepiece through which the image of an illuminated object may be viewed and a planar mirror, said method comprising the steps of:
(a) focusing the collimated light from the autocollimator to a focal plane and through the lens to the mirror;
(b) moving the autocollimator relative to the lens such that the focal plane of the autocollimator moves relative to the focal point of the lens;
(c) observing the focus of the image through the autocollimator eyepiece as the focal plane of the autocollimator moves relative to the focal point of the lens; and
(f) setting the position of the autocollimator such that the focal plane of the autocollimator coincides with the focal point of the lens by observing the sharpness of the image.

14. The method of claim 13 wherein the step of focusing the collimated light from the autocollimator to a autocollimator focal plane comprises the step of using a microscope objective to focus the collimated light from the autocollimator.

15. The method of claim 13 wherein the step of observing the focus of the image through the autocollimator eyepiece as the focal plane of the autocollimator moves relative to the focal point of the lens comprises the step of analyzing the observed image using photoelectric techniques.

16. A method for establishing infinity back focus of a cinematographic lens of the type having a focal point using a microscope objective, an autocollimator having a beam splitter eyepiece through which the image of an illuminated object may be viewed, and a planar mirror, said method comprising the steps of:
(a) focusing the collimated light from the autocollimator to a autocollimator focal plane using the microscope objective;
(b) moving the autocollimator relative to the lens such that the focal plane of the autocollimator moves relative to the focal point of the lens;
(c) observing the focus of the image through the autocollimator eyepiece as the focal plane of the autocollimator moves relative to the focal point of the lens; and
(d) setting the position of the autocollimator such that the focal plane of the autocollimator coincides with the focal point of the lens by observing the sharpness of the image.

17. Apparatus method for establishing infinity back focus of a cinematographic lens of the type having a focal point, said apparatus comprising: means for collimating light from an illuminated object; means for focusing the collimated light on a focal plane and through the lens; means for reflecting the light back through the lens and the focal plane to a position wherein the image can be observed; means for moving the focal plane relative to the focal point of the lens; and means for observing the focus of the image as the focal plane is moved relative to the focal point of the lens such that the position of the focal plane of the autocollimator coincides with the focal point of the lens can be determined by observing the sharpness of the image.

18. The apparatus of claim 17 wherein the means for collimating light from an illuminated object comprises an autocollimator.

19. The apparatus of claim 17 wherein the means of focusing the collimated light on a focal plane and through the lens comprises a microscope objective.

20. The apparatus of claim 17 wherein the means of reflecting the light back through the lens and the focal plane to a position wherein the image can be observed comprises a planar mirror.

21. The apparatus of claim 17 wherein the means of reflecting the light back through the lens and the focal plane to a position wherein the image can be observed comprises a beam splitter.

22. The apparatus of claim 17 wherein the means of observing the focus of the image as the focal plane moves relative to the focal point of the lens comprises a camera and monitor.

23. The apparatus of claim 17 wherein the means of observing the focus of the image as the focal plane moves relative to the focal point of the lens comprises means for numerically analyzing the image to derive the Modulation Transfer Function.

24. The apparatus of claim 23 wherein the means of numerically analyzing the image to derive the Modulation Transfer Function further comprises means of analyzing the image to derive the Modulation Transfer Function at a selected frequency.

25. The apparatus of claim 23 wherein the means of numerically analyzing the image to derive the Modulation Transfer Function further comprises means of analyzing the image to derive the Modulation Transfer Function over an appropriate Spatial Frequency Range.

26. Apparatus for establishing infinity back focus of a cinematographic lens of the type having a focal point using a planar mirror, said apparatus comprising: an autocollimator including a beam splitter eyepiece through which the image of an illuminated object may be viewed; a microscope objective for focusing the collimated light from said autocollimator to a autocollimator focal plane; means for moving the autocollimator relative to the lens such that the focal plane moves relative to the focal point of the lens; wherein said a beam splitter eyepiece allows observation of the focus of the image as the focal plane moves relative to the focal point of the lens; means for determining the position of the autocollimator when the observed image appears to be sharpest.

27. Apparatus for establishing infinity back focus of a cinematographic lens of the type having a focal point using a microscope objective and a planar mirror, said apparatus comprising: an autocollimator having a beam splitter eyepiece through which the image of an illuminated object may be viewed; a microscope objective for focusing the collimated light from the autocollimator through a focal plane and said lens to said mirror such that said mirror reflects the light back through the lens and said focal plane to the beam splitter eyepiece; means for moving the said autocollimator relative to said lens such that the focal plane moves relative to the focal point of the lens; means for observing the focus of the image through said beam splitter eyepiece as the focal plane moves relative to the focal point of the lens; photoelectric means for determining the position of the autocollimator when the observed image is sharpest.

28. The apparatus of claim 27 wherein said photoelectric means comprises a camera and a monitor.

29. The apparatus of claim 27 wherein said photoelectric means comprises means for numerically analyzing the image to derive the Modulation Transfer Function.
